(19) United States
(12) Patent Application Publication
(10) Pub. No.: US 2016/0080621 A1
(43) Pub. Date: Mar. 17, 2016

(54) VOICE COIL MOTOR AND AUTOFOCUS MODULE HAVING THE SAME

(71) Applicants: LITE-ON ELECTRONICS (GUANGZHOU) LIMITED, GUANGZHOU (CN); LITE-ON TECHNOLOGY CORP., TAIPEI (TW)

(72) Inventors: HSIN-YI PAI, TAIPEI CITY (TW); CHENG-JIE HE, GUANGDONG (CN); CHUN-LUNG LIN, TAIPEI CITY (TW)

(21) Appl. No.: 14/725,193

(22) Filed: May 29, 2015

(30) Foreign Application Priority Data
Sep. 15, 2014 (CN) 201420529092.8

(51) Int. Cl. H04N 5/225; H04N 5/232; H02K 41/035

(52) U.S. Cl. CPC H04N 5/2257; H02K 41/0356; H04N 5/23212; H04N 5/2253

(57) ABSTRACT

A voice coil motor includes a casing with a receiving space, a plurality of magnetic elements disposed in the receiving space, a carrier movably disposed in the receiving space for carrying a lens unit, a coil wrapped around the carrier, and a resilient member interconnecting the casing and the carrier to seal a gap between the casing and the carrier. The coil interacts with a magnetic field of the magnetic elements when energized for generating a driving force to displace the carrier. The resilient member is movable along with the carrier and is deformed to generate a restoring force that is opposite to the driving force.

### CROSS-REFERENCE TO RELATED APPLICATION

This application claims priority of Chinese Application No. 201420529092.8, filed on Sep. 15, 2014.

### FIELD OF THE INVENTION

The disclosure relates to a voice coil motor, and more particularly to a voice coil motor and an autofocus module having the same.

### BACKGROUND OF THE INVENTION

A conventional voice coil motor (VCM) is usually used in a lens module as a driving mechanism for focusing and zooming. The conventional voice coil motor mainly includes a casing, a plurality of permanent magnets, a carrier, a coil and at least one resilient plate. The carrier accommodates a lens module. The coil is wrapped around an outer peripheral surface of the carrier. The permanent magnets are disposed in the casing and have similar poles facing each other for providing a magnetic field. The magnetic field interacts with the energized coil so as to generate a magnetic force that drives movement of the carrier and the lens module along an optical axis of the lens module. The resilient plate interconnects the carrier and the casing, and provides a resilient reaction force on the carrier. Accordingly, the main principle of the voice coil motor is: Through interaction of the energized coil and the magnetic field of the permanent magnets, a driving force is derived to move the lens module along the optical axis, thereby achieving optically autofocus and/or zooming functions.

However, when the conventional voice coil motor is utilized on the lens module, because the resilient plate is only used to interconnect the carrier and the casing without sealing a gap therebetween, dirt or dust may easily fall into a space between the resilient plate and the casing and/or between the resilient plate and the carrier. As a result, the current structure of an assembly of the conventional voice coil motor and the lens module not only is prone to become dirty, but also cannot prevent water from entering the casing which may cause damage to the components therein. In addition, it is necessary for the voice coil motor to control the lens module in a precise manner. Needless to say, damage to any of the components may adversely affect the product reliability.

For that reason, how to solve the problem of dirt or dust falling into the autofocus lens module and simultaneously enhancing the reliability thereof are issues worth for further study.

### SUMMARY OF THE INVENTION

Therefore, an object of the present disclosure is to provide a voice coil motor that has a waterproof and dustproof structure and that can enhance reliability thereof.

According to one aspect of the present disclosure, a voice coil motor includes a casing, a plurality of magnetic elements, a carrier, a coil and a first resilient member. The casing defines a receiving space. The magnetic elements are disposed in the receiving space and have similar poles facing each other. The carrier is movably disposed in the receiving space for carrying a lens unit. The coil is wrapped around an outer peripheral surface of the carrier and is spacedly surrounded by the magnetic elements. The coil interacts with a magnetic field of the magnetic elements when energized for generating a driving force to displace the carrier. The first resilient member interconnects the casing and the carrier to seal a gap between the casing and the carrier. The first resilient member is movable along with the carrier and is deformed to generate a restoring force that is opposite to the driving force.

In the aforesaid voice coil motor, the first resilient member interconnects top peripheries of the casing and the carrier.

In the aforesaid voice coil motor, the voice coil motor further includes a second resilient member that interconnects bottom peripheries of the casing and the carrier. The second resilient member is movable along with the carrier and is deformed to generate another restoring force that is opposite to the driving force.

In the aforesaid voice coil motor, the second resilient member seals a gap between the bottom peripheries of the casing and the carrier.

In the aforesaid voice coil motor, the first resilient member is an elastic film.

In the afore said voice coil motor, the first resilient member is made of silicone or rubber.

In the aforesaid voice coil motor, the voice coil motor further includes a supporting seat connected to a bottom periphery of the casing.

Another object of the pre sent disclosure is to provide an autofocus module having a voice coil motor that has a waterproof and dustproof structure.

Ac cording to another aspect of the present disclosure, an autofocus module includes a casing, a plurality of magnetic elements, a lens unit, a coil and a first resilient member. The casing defines a receiving space. The magnetic elements are disposed in the receiving space and have similar poles facing each other. The lens unit is disposed in the receiving space and has an optical axis. The coil is wrapped around an outer peripheral surface of the lens unit and is spacedly surrounded by the magnetic elements. The coil interacts with a magnetic field of the magnetic elements when energized for generating a driving force to displace the carrier along the optical axis. The first resilient member interconnects the casing and the lens unit to seal a gap between the casing and the lens unit. The first resilient member is movable along with the lens unit and is deformed to generate a restoring force that is opposite to the driving force.

In the aforesaid autofocus module, the first resilient member interconnects top peripheries of the casing and the lens unit.

In the aforesaid autofocus module, the autofocus module further includes a second resilient member that interconnects bottom peripheries of the casing and the lens unit. The second resilient member is movable along with the lens unit and is deformed to generate another restoring force that is opposite to the driving force.

In the aforesaid autofocus module, the second resilient member seals a gap between the bottom peripheries of the casing and the lens unit.

In the aforesaid autofocus module, the first resilient member is an elastic film.

In the aforesaid autofocus module, the first resilient member is made of silicone or rubber.

In the aforesaid autofocus module, the autofocus module further includes a supporting seat that is connected to a bottom periphery of said casing.

### BRIEF DESCRIPTION OF THE DRAWINGS

Other features and advantages of the present disclosure will become apparent in the following detailed description of the embodiment with reference to the accompanying drawings, of which:

FIG. 1 is an exploded perspective view of an autofocus module according to the embodiment of the present disclosure;

FIG. 2 is a perspective view of the embodiment in an assembled state;

FIG. 3 is an assembled sectional view of the embodiment;

FIG. 4 is an exploded perspective view of an alternative form of the embodiment; and

FIG. 5 is an assembled sectional view of FIG. 4.

### DETAILED DESCRIPTION OF THE EMBODIMENT

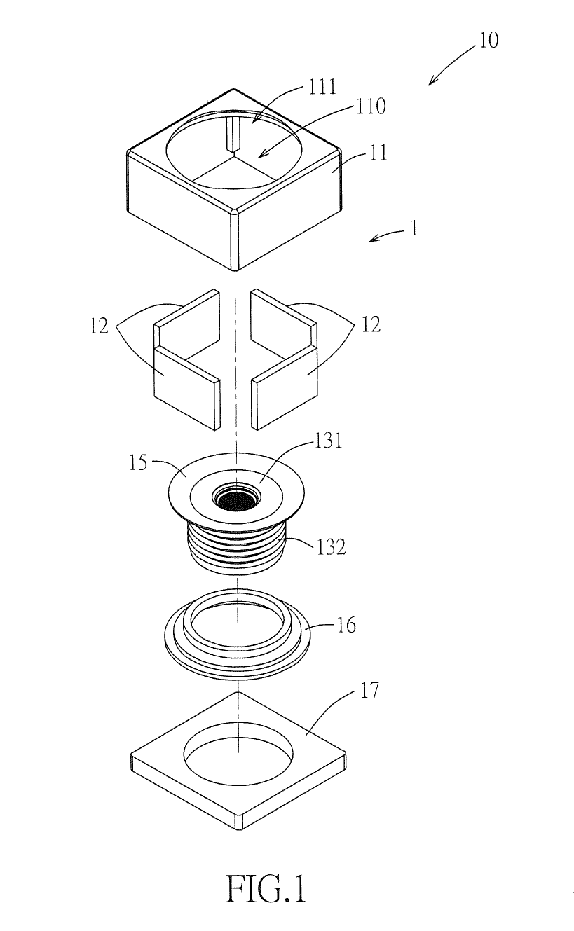

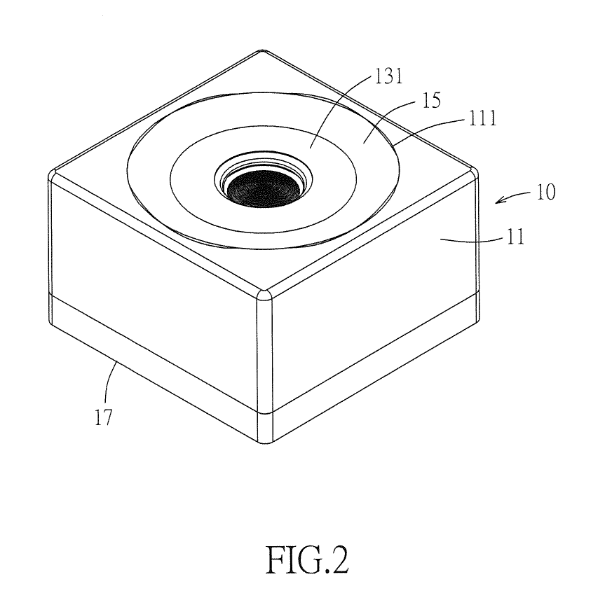

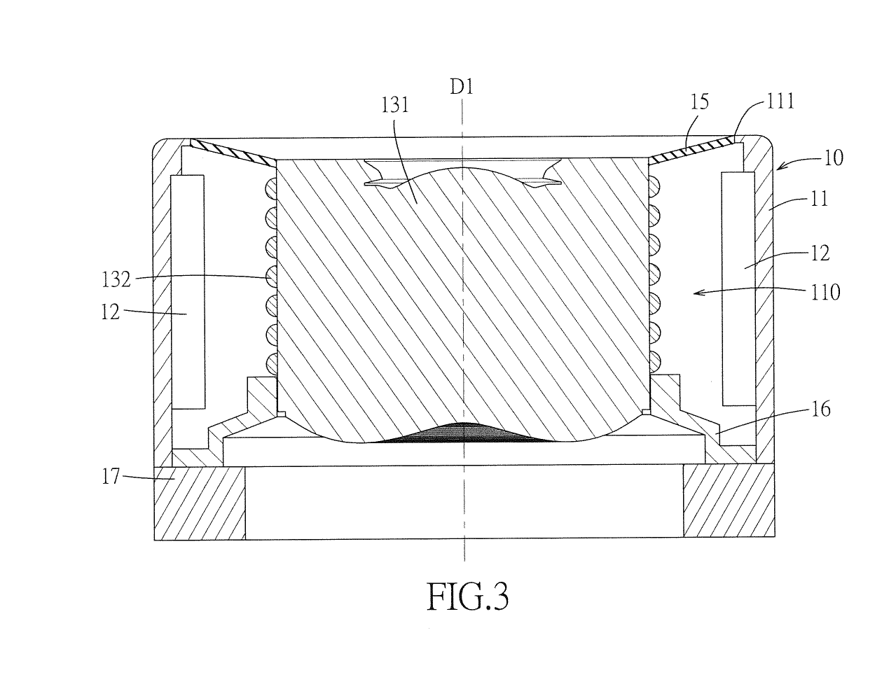

Referring to FIGS. 1 to 3, the embodiment of an autofocus module 10 according to the present disclosure includes a voice coil motor 1 and a lens unit 131.

The voice coil motor 1 includes a casing 11, four magnetic elements 12, a coil 132, a first resilient member 15, a second resilient member 16 and a supporting seat 17.

The casing 11 defines a receiving space 110 with an opening 111. The magnetic elements 12 are disposed in the receiving space 110. In this embodiment, the magnetic elements 12 are permanent magnets and have similar poles facing each other. Alternatively, each of the magnetic elements 12 may be made of a material capable of generating a magnetic field, and is not limited to the aforesaid disclosure.

The lens unit 131 and the coil 132 are disposed in the receiving space 110 of the casing 11. The lens unit 131 has an optical axis (D1). Since the lens unit 131 is a conventional component, a detailed description of the same is omitted herein for the sake of brevity. In this embodiment, the coil 132 is wrapped around an outer peripheral surface of the lens unit 131 and is spacedly surrounded by the magnetic elements 12. Specifically, the coil 132 interacts with a magnetic field of the magnetic elements 12 when energized for generating a driving force to displace the carrier 14 along the optical axis (D1), thereby performing an autofocus or auto-zooming operation for capturing images.

The first resilient member 15 interconnects top peripheries of the casing 11 and the lens unit 131 to seal a gap between the casing 11 and the lens unit 131. In addition, the first resilient member 15 is movable along with the lens unit 131 and is deformed to generate a restoring force that is opposite to the driving force, thereby controlling a position of the lens unit 131. Through this, the resilient member 15 can prevent dirt or water from entering the receiving space 110 to achieve dustproof and waterproof effects. Further, components inside the autofocus module 10 can be prevented from being damaged. Therefore, the reliability of the autofocus module 10 is increased. In this embodiment, the resilient member 15 is an elastic film that is made of silicone. However, the material of the resilient member 15 is not limited to this disclosure, and may be made of rubber or the like.

The supporting seat 17 is connected to a bottom periphery of the casing 11. The second resilient member 16 interconnects bottom peripheries of the casing 11 and the lens unit 131 to seal a gap between the bottom peripheries of the casing 11 and the lens unit 131. Through the presence of the first and second resilient members 15, 16, dirt or dust can be prevented from entering an imaging area of the lens unit 131. In this embodiment, the second resilient member 16 is movable along with the lens unit 131, and is deformed to generate another restoring force that is opposite to the driving force. The second resilient member 16 may be configured as a conventional resilient plate.

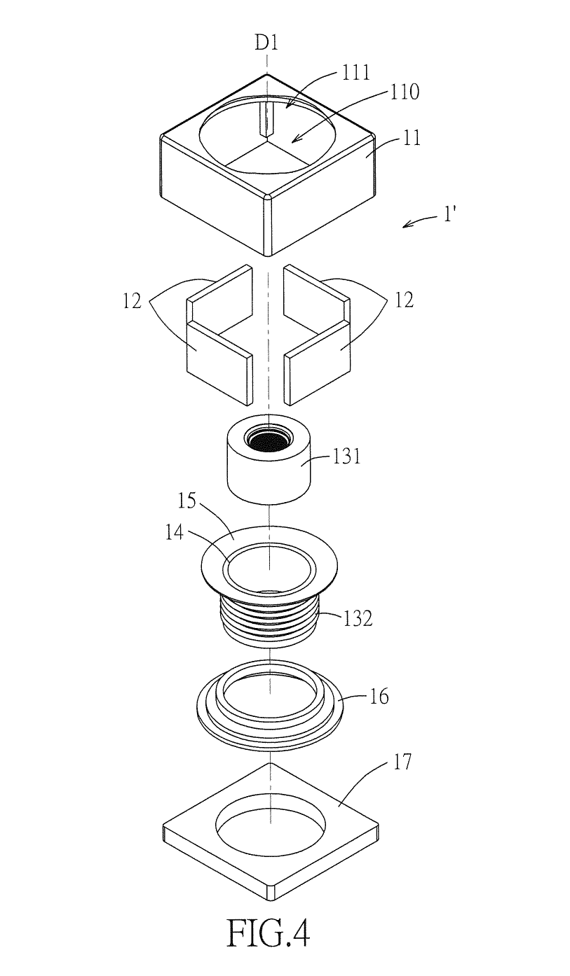

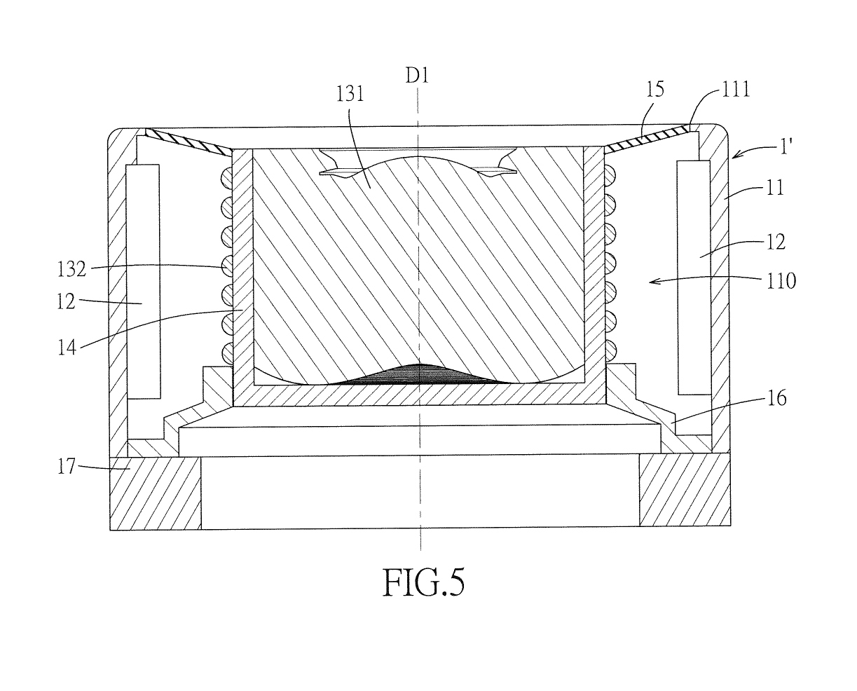

Referring to FIGS. 4 and 5, an alternative form of the voice coil motor 1′ according to the present disclosure further includes a carrier 14 movably disposed in the receiving space 110 for carrying the lens unit 131. In this embodiment , the coil 132 is wrapped around an outer peripheral surface of the carrier 14 and is spacedly surrounded by the magnetic elements 12. The coil 132 interacts with a magnetic field of the magnetic elements 12 when energized for generating a driving force to displace the carrier 14 along the optical axial (D1) of the lens unit 131. The first resilient member 15 interconnects top peripheries of the casing 11 and the carrier 14 to seal a gap between the casing 11 and the carrier 14. The first resilient member 15 is movable along with the carrier 14, and is deformed to generate a restoring force that is opposite to the driving force. The second resilient member 16 interconnects bottom peripheries of the casing 11 and the carrier 14 to seal a gap between the bottom peripheries of the casing 11 and the carrier 14. Through the presence of the first and second resilient members 15, 16, dirt or dust can be prevented from entering the imaging area of the lens unit 131. Further, the second resilient member 16 is movable along with the carrier 14 and is deformed to generate another restoring force that is opposite to the driving force.

To sum up, since the first resilient member 15 interconnects the top periphery of the casing 11 and the top periphery of one of the lens unit 131 and the carrier 14 to seal a gap between the casing 11 and the one of the lens unit 131 and the carrier 14, and since the second resilient member 16 interconnects the bottom periphery of the casing 11 and the bottom periphery of one of the lens unit 131 and the carrier 14 to seal a gap between the casing 11 and the one of the lens unit 131 and the carrier 14, dirt/dust or water can be prevented from entering the receiving space 110 in the casing 11 to achieve dustproof and waterproof effects of the autofocus module 10. As such, the components inside the autofocus module 10 can be prevented from being damaged. Therefore, the objects of the present disclosure can be realized.

While the present disclosure has been described in connection with what is considered the most practical embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A voice coil motor comprising:
a casing defining a receiving space;
a plurality of magnetic elements disposed in said receiving space and having similar poles facing each other;
a carrier movably disposed in said receiving space for carrying a lens unit;
a coil wrapped around an outer peripheral surface of said carrier and spacedly surrounded by said magnetic elements, said coil interacting with a magnetic field of said magnetic elements when energized for generating a driving force to displace said carrier; and
a first resilient member interconnecting said casing and said carrier to seal a gap between said casing and said carrier, said first resilient member being movable along with said carrier and being deformed to generate a restoring force that is opposite to the driving force.

2. The voice coil motor as claimed in claim 1, wherein said first resilient member interconnects top peripheries of said casing and said carrier.

3. The voice coil motor as claimed in claim 1, further comprising a second resilient member that interconnects bottom peripheries of said casing and said carrier, said second resilient member being movable along with said carrier and being deformed to generate another restoring force that is opposite to the driving force.

4. The voice coil motor as claimed in claim 3, wherein said second resilient member seals a gap between said bottom peripheries of said casing and said carrier.

5. The voice coil motor as claimed in claim 1, wherein said first resilient member is an elastic film.

6. The voice coil motor as claimed in claim 1, wherein said first resilient member is made of silicone or rubber.

7. The voice coil motor as claimed in claim 1, further comprising a supporting seat connected to a bottom periphery of said casing.

8. An autofocus module comprising:
a casing defining a receiving space;
a plurality of magnetic elements disposed in said receiving space and having similar poles facing each other;
a lens unit disposed in said receiving space and having an optical axis;
a coil wrapped around an outer peripheral surface of said lens unit and spacedly surrounded by said magnetic elements, said coil interacting with a magnetic field of said magnetic elements when energized for generating a driving force to displace said carrier along the optical axis; and
a first resilient member interconnecting said casing and said lens unit to seal a gap between said casing and said lens unit, said first resilient member being movable along with said lens unit and being deformed to generate a restoring force that is opposite to the driving force.

9. The autofocus module as claimed in claim 8, wherein said first resilient member interconnects top peripheries of said casing and said lens unit.

10. The autofocus module as claimed in claim 8, further comprising a second resilient member that interconnects bottom peripheries of said casing and said lens unit, said second resilient member being movable along with said lens unit and being deformed to generate another restoring force that is opposite to the driving force.

11. The autofocus module as claimed in claim 10, wherein said second resilient member seals a gap between said bottom peripheries of said casing and said lens unit .

12. The autofocus module as claimed in claim 8, wherein said first resilient member is an elastic film.

13. The autofocus module as claimed in claim 8, wherein said first resilient member is made of silicone or rubber.

14. The autofocus module as claimed in claim 8, further comprising a supporting seat that is connected to a bottom periphery of said casing.
